(19) United States
(12) Patent Application Publication
(10) Pub. No.: US 2001/0036128 A1
(43) Pub. Date: Nov. 1, 2001

(54) Electronic timepiece

(76) Inventor: Araki Fujio, Nisinomiya City (JP)

Correspondence Address: William B. Noll, 402 Anemone Street, Panama City Beach, FL, 32413, US

(21) Appl. No.: 09/749,850

(22) Filed: Dec. 28, 2000

(30) Foreign Application Priority Data
May 1, 2000 (JP) P-10929

(51) Int. Cl. G04C 19/00; G04C 17/00

(52) U.S. Cl. 368/82; 368/239

(57) ABSTRACT

A binary coded decimal (BCD) operable electronic timepiece devoid of rotating hands and digital readout numbers. The timepiece, in a preferred embodiment, may be as a timepiece worn on a wearer's wrist, but other applications, such as wall mounted, mantle, and as a display unit in sports arenas and stadiums. The timepiece features a face having plural windows to be illuminated in various mathematical sequences, where the windows may be assigned different values to designate the time and date. The timepiece is operable by a powered electronic circuitry, and may include mechanisms for the handicapped, i.e. hearing and/or sight impaired, to read the time and date.

### FIELD OF THE INVENTION

This invention is directed to the field of electronic timepieces, more particularly to a wrist-type timepiece that is void of numbers and hands to designate time, but rather utilizes a binary coded decimal counter to illuminate a plurality of windows operable in mathematical sequences to designate the time.

### BACKGROUND OF THE INVENTION

The present invention relates to a unique electronic timepiece, such as may be worn on one's wrist, that incorporates a plurality of illuminated windows, operable in mathematical sequences, to reveal the time. The respective windows may be overlaid with a light transmitting medium, such as artificial or natural gems of different colors, to become a utilitarian item of jewelry.

Timepieces, particularly as watches worn on one's wrist, have evolved over the past years from wind up spring mechanisms, to battery powered mechanisms. To indicate the time the very early versions used hour and minute hands, with often a sweeping seconds hand. Later, display devices or read-out mechanisms were developed to give the wearer a numerical indication of the time. The respective mechanisms were enhanced with the further features of day and date, such as by rotating wheels exposed through windows in the watch face. To make the watches more fashionable, it was not uncommon to enhance its appearance by the use of jewels, particularly in the band for securing the watch to the wearer's wrist. The following U.S. Patents represent several recent developments in trying to enhance the appearance and operation of a wrist worn timepiece:

a.) U.S. Pat. No. 5,995,4546, to Brewer, et al., teaches a dynamically changing, multi-color liquid crystal display for electronic watches or other design apparel items. The liquid crystal displays incorporated within the watch or designer apparel item can be adapted to provide various colored images such as geometric images, animation images, customized images, designer labels, logos, etc. on colored backgrounds or alternatively provides a color changing capability that is aesthetically pleasing and fashionable. Moreover, the dynamically changing watch or other designer apparel item allows for the electronic control of the color appearance of the liquid crystal displays as well as electronic control of the liquid crystal display images, such images being generally independent of the time of day.

b.) U.S. Pat. No. 4,862,435, to Reichel, et al., relates to the combination bracelet and wristwatch comprising a watch case including a bezel, a crystal, and a case back, the watch case containing a movement, dial and hands disposed therein, wherein the hands are viewable from one side of the case through the crystal. The case back defines a recessed well facing the exterior side and includes a decorative insert disposed in the well, a pair of opposed spindles projecting from opposite sides of the bezel, and a bracelet attachment including articulated chain elements. Further means are attached between selected chain elements and spindles for rotatably and pivotally mounting the watch case on the bracelet attachment. In a preferred embodiment of the invention, the means rotatably mounting the watch case comprises a pair of collars disposed on the spindles and having a pair of hooks each extending through an articulated chain element and having opposed ends pivotally cooperating with the collars.

c.) U.S. Pat. No. 4,403,869, to Crutcher, is directed to the combination of a timepiece and electro-optic identification device employing elements of the timekeeping display. The combination includes a programmable read only memory storing a number of identification codes with means for selecting the code and transmitting it from the memory via an electro-optic display portion on the timekeeping display, to an opto-electronic reader placed in proximity with the timepiece. The code selected may be unique to the device itself, may be selected by the user, and a machine-readable code representative of the time, or may be a combination of any of the above codes.

The present invention represents a complete departure from the prior art in that it avoids the use of rotating hands and digital readouts of numbers for indicating time. A further feature of this invention is the provision of a unique timepiece that may be aesthetically enhanced by incorporating gems onto the face, particularly light transmitting natural or artificial gems. The manner by which this invention introduces a new generation of timepieces, with a unique way of indicating time, will become clearer in the description which follows.

### SUMMARY OF THE INVENTION

This invention is directed to a unique electronic timepiece, preferably in the form of a wrist watch, where the timepiece operates on a binary coded decimal counter to illuminate selected display windows in mathematical sequences. Even though a wrist watch is the preferred form for the invention, the mechanism is equally applicable for a wall clock, mantle clock, and in large display clocks, such as may be used in a sports arena or stadium. As a wrist worn timepiece, it has the further advantage to be worn as an item of jewelry, especially when enhanced by the addition of light transmitting gems, natural and artificial. The timepiece, devoid of rotating hands and displayed numbers, comprises a housing having a generally planar face featuring three rows of plural windows in a given row. A first row, arranged on the left, designates the hours, a second or middle row designates minutes in integrals of ten, and a third row, arranged on the right, designates minutes from zero to nine. The first row has four windows, where the windows are sequentially assigned the hour designations of “1”, “2”, “4” and “8” hours. By the selective illumination of one or more of the windows, values from 1 to 12 can be designated, i.e. 1+4=5, or 1+2+8=11, etc. The second or middle row has three windows with the windows sequentially assigned the ten second values of “10”, “20” and “40”. In similar fashion, selective combinations of the numbers, or none of the numbers, can be illuminated to yield values from 0 to 50. The final or third row comprises four windows sequentially assigned the minute designations of “1”, “2”, “4” and “8”. Similarly to the hour designators, by illuminating selective combinations of the windows, minutes from 0 to 9 can be designated. By way of example,

10:47 o'clock=(8+2), (40), and (1+2+4), rows 1, 2, 3 respectively, and

3:29 o'clock=(1+2), (20), and (1+8), rows 1, 2, 3 respectively.

Thus, by simple addition, the wearer can easily and readily read the time, while those nearby may think the timepiece is just an item of jewelry. Optionally, the timepiece may include a continuously moving “seconds” bar, date designating means, plus means to emit sounds or vibrating member to assist the handicapped in using the timepiece.

Accordingly, an object of the invention is to provide a unique timepiece that in the form of a wrist worn timepiece can double as a jewel bedecked fashion item.

Another object hereof is the provision of a revolutionary timepiece that eliminates the need for rotating hands and digital readout numbers, but rather relies on light emitting windows that use a mathematic sequence and combinations of lighted windows to designate date and time in a unique manner.

These and other objects will become more apparent in the description which follows, particularly by those skilled in the art.

### BRIEF DESCRIPTION OF DRAWINGS

FIG. 1 is a simplified block diagram of the operating system for the electronic timepiece according to the present invention.

FIG. 2 is a simplified illustration of the day and time for the timepiece hereof, where the two left items designate the date, the three right items designate the time, and the lower item the seconds, i.e. the 23rd day at 10:35 and 30 seconds.

FIG. 3 illustrates alternative arrangements for providing illumination to the various windows on the timepiece face to designate times and other functions.

FIG. 4 is a perspective view of the unique timepiece of this invention, in the preferred form of a wrist worn timepiece, showing the timepiece face and partial wrist straps.

FIGS. 5A through 5F are various plan views of simplified timepiece faces, according to this invention, showing exemplary times, respectively, the times: 6:13, 8:41, 1:48, 9:01, 5:34, and 2:50.

### DETAILED DESCRIPTION OF PREFERRED EMBODIMENT

This invention is directed to a revolutionary timepiece that is devoid of rotating hands and digital readout numbers. The invention relies upon a binary coded decimal (BCD) counter to selectively light a plurality of windows in the timepiece face, where different combinations of said windows readily show the time and date to the wearer, if a wrist worn timepiece, or to observers who understand the sequence combinations. The manner by which this unique timepiece can be used to designate times and dates will become clearer in the description and Figures which follows, where like reference numerals represent like components or features throughout the various views.

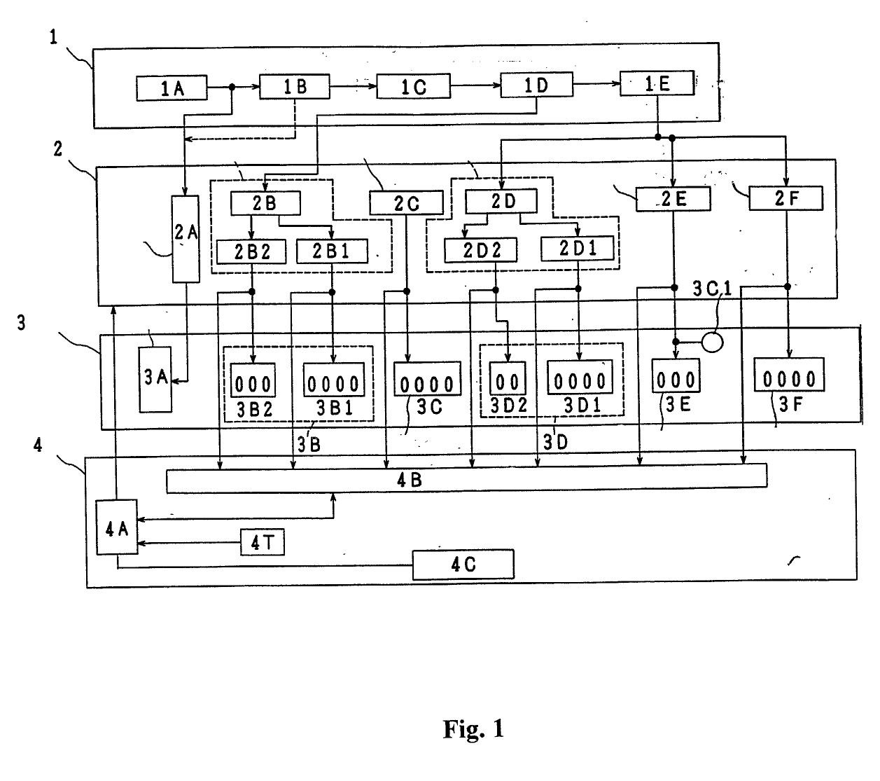

Turning first to FIG. 1, which is a simplified block diagram of the operating system “S” for the timepiece of this invention, where the system S comprises four functioning and interrelated subsystems, namely, electron time mechanism 1, signal converter 2, signal indicator 3 and sound indicator 4. The time mechanism 1 includes a standard time mechanism 1A, as known in the art, that is continuously activated and/or powered, where energizing of the mechanism may be through solar or body heat, and further accumulates frequency and creates sounds which send a signal to the second to minute converter 1B every 60 seconds to change to minutes. The converter 1B, in turn, sends a signal every 60 minutes to the minute to hour converter 1C to change minutes to hours. The converter 1C sends a signal to the hour to day converter 1D twice during a 24 hour day. Finally, the converter 1D sends a signal to the year-month-day converter 1E in accordance with conventional calendars.

The signal converter 2, also continually activated, is a signal changing mechanism. The seconds changing converter 2A, at “0” seconds, signals the seconds indicator 3A to change the minute indicator 3B. The seconds indicator 3A has 60 separate illuminating lights to flicker the seconds mechanism 1A, which sends a signal to the seconds indicator 3A to extinguish the lights to begin again. However, the seconds signal does not come from the seconds mechanism 1A, but rather from the second to minute converter 1B. The signal is read by the seconds converter 2A to activate the seconds indicator 3A. Alternatively, the seconds indicator 3A may be turned off when desired. Notwithstanding, the timepiece will continue its maintenance of the time and date.

The minute converter 2B sends a signal to the minute to hour converter 1C on a ten count signal which is split to change the minutes in segments of ten for the minute converter 2B1 and single minute converter 2B2, which in turn, respectively, send signals to the minute indicators 3B2 and 3B1. Similarly, the hour to day converter 1D sends a signal to the day converters 2D1 and 2D2, thence a signal to the hour indicators, respectively, hour indicators 3D1 and 3D2. To effect a change in the “date”, on the basis of two twelve time segments, a signal is sent to the day indicator to effect a change corresponding to the PM time change.

The day converter 2D reads the signal year, month, day change from the converter 1E. The day converter 2D, as noted above, sends signals to the respective day converters 2D1 and 2D2. The signal is split for the single digits to converter 2D1 to designate the last digit of the “date” from 0 to 9 on the indicator 3D1, while the balance of the split signal is sent to converter 2D2 in integrals of “10”, thence to indicator 3D2, for the values “10”, “20” and “30”. Thus, in combination, the respective indicators will display the designations from 1 to 31. That is, the initial signal from converter 2D goes to the converter 2D1 for the days 1 to 9, whereupon at 10 minutes a signal goes to converter 2D2 and the “date” indicator 3D1 reverts to “0” and indicator designate “10”. Upon reaching “0” again, a second signal to sent to converter 2D2 to designate “20”.

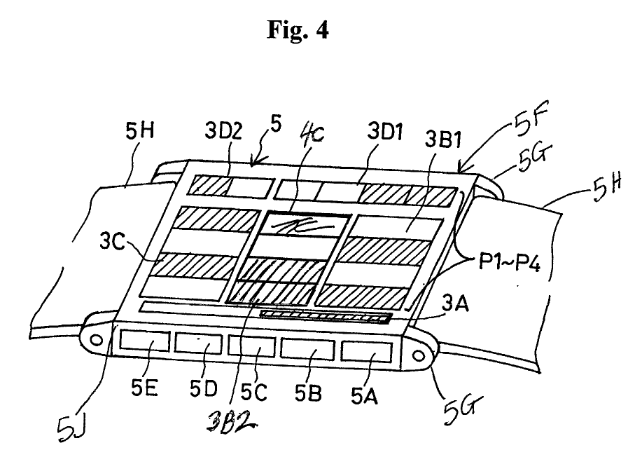

For the visually impaired, the sound indicator 4, continuously activated, emits a sound from the sound producing control mechanism 4A through the sound producing mechanism 4C, see FIG. 4. The mechanism may be activated by pressing input port 4T (receive signal from 5C and 5D), where input port 4T reads a signal from signal converter 2. The signal can be programmed to yield different sounds and vibrations to reflect the time (5C) and day, week (5D).

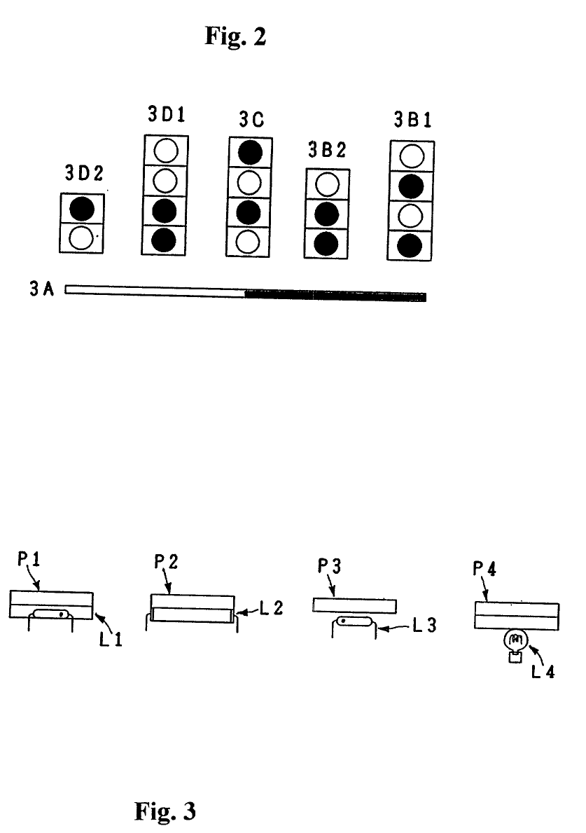

FIG. 2 illustrates how the timepiece display of this invention may be used as a wall or mantle clock, or as a billboard display for large sports arenas and stadiums. In this illustration, the illuminating windows 3D2 and 3D1 designate the “date”, 3C the “hours”, 3B2 and 3B1 the minutes, and 3A the “seconds”. The principle by which the system hereof operates is based on the combination of matiematic sequences that may be readily translated into specific times, and the day of the month. For the illuminating windows 3D2, the two shown windows have the assigned values of “10” and “20”, bottom and top, respectively. Thus, no illumination is equal to zero, while illuminated together they equal “30”. The illuminating window 3D1 illustrates the single digits, specifically the values of “1”, “2”, “4” and “8”, bottom to top, respectively. Further, it will be apparent that by illuminating different combinations of windows, or none at all, the values of 0 to 9 are possible. In the illustration of FIG. 2, the “date” is the 23rd of the month. A similar principle is followed for time. Illuminating window 3C represents the hours, with the several windows assigned the values of “1”, “2”, “4” and “8”. By selectively combining different windows, it is possible to illuminate one or more windows to designate the hours from 1 to 12. In this embodiment, the “2” and “8” are illuminated to designate the hour to be 1 “10”. The remaining illuminating windows 3B2 and 3B1 represent the minutes. The windows 3B2 are assigned the values of “10”, “20” and “40”, bottom to top, respectively. Thus, combinations of from zero (no illumination) to 50 are possible. When combined with the illuminating windows 3B1, minutes are accurately designated. The windows are assigned the values “1”, “2”, “4” and “8”, bottom to top, respectively. In this embodiment, the minutes are “35”, and by combining the windows 3C, 3B2 and 3B1 the time becomes 10:35. At the bottom is the seconds indicator 3A, where the illumination scans the length of the elongated window every 60 seconds, then repeated. At the end of the scan, the minutes change in accordance with a standard clock.

One of the significant features of this invention is the provision of an item of jewelry by overlaying the operating face in various types of light transmitting gems, including natural and artificial gems. FIG. 3, in a simplified form, illustrates how the respective windows may be illuminated by color liquid crystal display or light bulbs L1 to L4, underlying or within a first substrate. Overlying the first substrate may be a clear or semi-clear glass substrate P1 to P4, which may include or be replaced by light transmitting gems, as noted above.

A preferred embodiment for the timepiece 1 hereof is illustrated in FIG. 4. Such preferred embodiment may be a wrist worn timepiece 5, such as rectangular in shape, comprising a housing 5F having a pair of wing members 5G extending from the housing for securing the respective ends of a band 5H, as known in the art. The generally planar face displays the various illuminating widows, as described above, while a side face 5J mounts a plurality of timepiece operating functions. The side face 5J includes the ON/OFF switch 5A, to activate the illuminations for the “date” and “time”. Further, the side face includes a second switch 5B should one wish to deactivate the illumination of the seconds indicator 3A. Additionally, other functioning switches are provided, namely, a sound or vibration switch 5C as may be helpful for the hearing or seeing impaired, an ON/OFF switch SD for sound, and a final switch 5E for operating the illumination in a first “bright” mode, or a reduced light mode that allows the wearer to also tell time, such as during the day or at night.

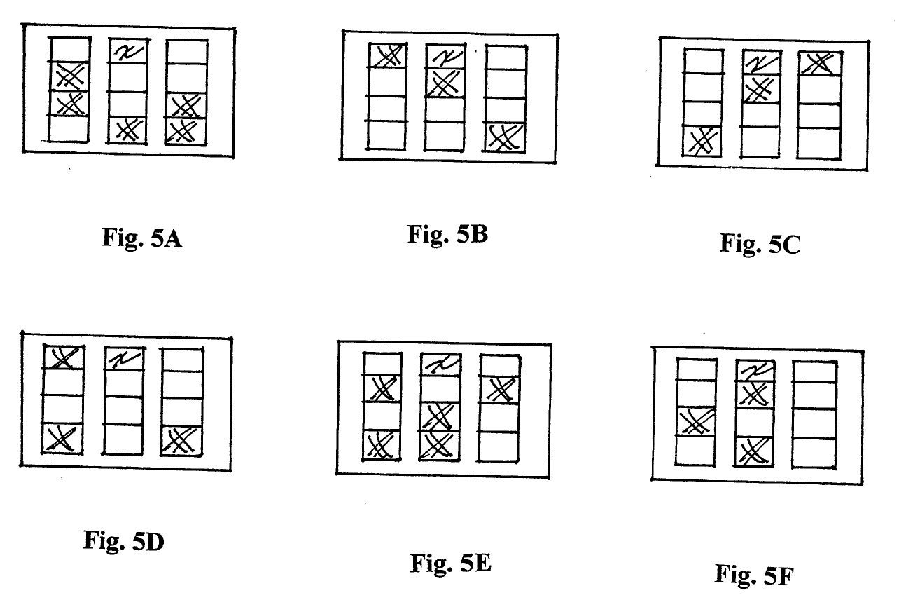

FIGS. 5A to 5F illustrate some simplified timepieces 1 according to the present invention. By using the mathematic sequencing and combining described with regard to FIG. 3, one can readily calculate the respective times as follows:

FIG. 5A=6:13

FIG. 5B=8:41

FIG. 5C=1:48

FIG. 5D=9:01

FIG. 5E=5:34, and

FIG. 5F=2:50.

It is recognized that variations, changes and modifications may be made to the timepiece of this invention, particularly by those skilled in the art, without departing from the spirit and scope of the invention. Accordingly, no limitation is intended to be imposed thereon except as set forth in the appended claims.

1. A binary coded decimal operable electronic timepiece devoid of numbers and rotating hands, said timepiece comprising:
a.) a housing having a generally planar face featuring three rows of plural windows in a given row, where a first row designates the hour, a second row designates minutes in integrals of ten, and a third row designates minutes from zero to nine; and,
b.) powered electronic means within said housing to illuminate selected windows to designate a time.

2. The electronic timepiece according to claim 1, wherein there are four windows in said first row sequentially assigned mathematic values for the hour designations of “1”, “2”, “4” and “8” hours, such that different combinations of said illuminated windows may be used for the hours from 1 to 12.

3. The electronic timepiece according to claim 2, wherein there are three windows in said second row sequentially assigned mathematic values for the ten minute designations of “10”, “20” and “40” minutes, such that different combinations of said illuminated windows may be used for ten minute intervals of from 10 to 50.

4. The electronic timepiece according to claim 3, wherein there are four windows in said third row sequentially assigned mathematic values for the minute designations of “1”, “2”, “4” and “8”, such that different combinations of said illuminated windows may be used for minutes from 0 to 9.

5. The electronic timepiece according to claim 4, wherein there is a single elongated window having a constant moving illumination along its length, where the time to traverse said window is “60” seconds.

6. The electronic timepiece according to claim 1, including two sets of side-by-side windows on said planar face to designate the date, where a left set has two windows assigned the integers “1” and “2”, and a right set has four windows assigned the integers “1”, “2”, “4”, and “8”, and means within said housing to selectively illuminate different combinations of said date windows to designate dates from 1 to 31.

7. The electronic timepiece according to claim 6, wherein said left set designates the integers “10”, “20” and “30” and said right set designates the single integers from 0 to 9.

8. The electronic timepiece according to claim 1, wherein at least one said window is overlaid with light transmitting gems, selected from the group consisting of natural and artificial gems.

9. The electronic timepiece according to claim 8, wherein said timepiece is a device worn on a wearer's wrist, and includes an ON/OFF switch to conserve energy from said powered electronic means.

10. The electronic timepiece according to claim 8, including audio means for emitting vibrating sounds in decimal counts to designate the date and time.

11. The electronic timepiece according to claim 1, wherein said timepiece is adapted to be worn on a wearer's wrist, including means to removably secure said timepiece to said wrist, where said housing has a wall essentially perpendicular to said planar face having switch means mounted thereon to effect an ON/OFF of said powered electronic means.

12. The electronic timepiece according to claim 11, including means on said wall to activate a vibrating mechanism for the seeing impaired.

13. The electronic timepiece according to claim 11, including a further switching means on said wall for illuminating said windows at first and second levels of illumination.

14. The electronic timepiece according to claim 11, including a second switching means on said wall to activate an audio means.
